(19) United States
(12) Patent Application Publication
(10) Pub. No.: US 2008/0008841 A1
(43) Pub. Date: Jan. 10, 2008

(54) Method For Increasing Surface Energy Of Low Energy Substrate Utilizing A Limited Length Corona Or Plasma Discharge Treatment To Improve Adherence Of A Subsequently Applied Secondary Coating Thereto

(76) Inventors: Ralph Locke, Fort Myers, FL (US); Roger C. Jaussi, Novi, MI (US)

Correspondence Address: Dickinson Wright PLLC, 38525 Woodward Avenue, Suite 2000, Bloomfield Hills, MI, 48304, US

(21) Appl. No.: 11/626,938

(22) Filed: Jan. 25, 2007

Related U.S. Application Data
(60) Provisional application No. 60/806,577, filed on Jul. 5, 2006.

(51) Int. Cl. B05D 7/00; B05D 1/36; B05D 3/14; H05H 1/24

(52) U.S. Cl. 427/562; 427/569; 427/402; 427/212

(57) ABSTRACT

A method for improving the adhesion characteristics of a secondary coating to a coated substrate material using a corona or plasma discharge treatment, in which the treatment is limited to a finite duration of time sufficient to increase the surface energy of the coated substrate above that of the secondary coating but insufficient to cause a loss or diminishment of the adhesion between any layers of coating of the coated substrate material or between the bottommost layer of the coating and the bare substrate. A secondary coating is applied to the treated substrate and at a desired thickness and cured or dried, depending upon its composition. The limited duration discharge treatment functions to improve the adhesion of the secondary coating to the coated substrate material without adversely affecting any previously applied coating layers.

### CROSS REFERENCE TO RELATED APPLICATION

The present invention claims priority from U.S. Provision Application Ser. No. 60/806,577, filed Jul. 5, 2006, entitled “Method For Increasing Surface Energy of Low Energy Substrate Utilizing A Limited Length Corona Or Plasma Discharge Treatment To Improve Adherence Of A Subsequently Applied Secondary Coating Thereto,”

### TECHNICAL FIELD

The present invention relates to a method for improving the adherence of a secondary coating applied to a surface of a substrate material and more specifically to a method for increasing surface energy of a low energy substrate prior to the introduction of the secondary coating utilizing a limited length corona or plasma discharge treatment to improve the adherence of the secondary coating to the substrate material.

### BACKGROUND OF THE INVENTION

The present invention is directed at a method for applying and adhering a secondary coating, preferably a relatively high surface energy polymeric coating, to a lower surface energy treated substrate material.

Measured in dyne/cm (mili N/m), surface energy, or surface energy, is the deciding factor on how well a liquid adheres to a substrate surface. For a proper bond to exist between a liquid and a substrate surface, the substrate's surface energy typically must exceed the liquid's surface energy by about 2-10 dyne/cm. The higher the surface energy of the substrate in relation to the liquid, the better its “wettability.”

Corona treatment is a common method of increasing surface energy on low surface energy substrates to promote adhesion when printing, coating or laminating. Corona treatment systems are made of several components designed to apply a high voltage, high frequency electrical discharge to the substrate.

When atmospheric air is exposed to different voltage potentials, electrical discharge can develop. When this occurs, it results in an avalanche effect caused by the collision of neutral molecules and the electrically loaded molecules, which make up the voltage. Upon collision, the neutral molecules become electrically loaded, resulting in a heavily loaded zone or “lightening”. This, in turn, creates a heavy oxide mixture of ozone and nitrogen oxides. To avoid this avalanche effect, an isolator is placed between two electrodes. The result is a cloud of ionized air—or the Corona discharge—which is then used for surface treatment of substrate materials.

When a substrate material is placed under the Corona discharge, the electrons generated in the discharge impact on the treatment surface with energies two to three times that necessary to break the molecular bonds on the surface of most substrates. The resulting free radicals react rapidly with the oxidating products of Corona discharge, or with adjoining free radicals on the same or different chain, resulting in a cross-link. Oxidation of the solid surface increases the surface energy, allowing for better wetting by liquids and promoting adhesion. Though studies have shown that development of strong oxidants is not essential for adhesion to take place, wetting tension is most assuredly related to the oxidation of the polymer surface resulting in polar groups on the surface, primarily hydroxyl, carbonyl and amide groups.

A related technology to Corona treatment that is used to increase surface energy on low surface energy substrates is the recent introduction of high-density atmospheric plasma treatment. Like corona, plasma is the electrical ionization of a gas, but with plasma the gas is selected dependent on the material being treated and the application being performed. The plasma (glow) discharge creates a smooth, undifferentiated cloud of ionized gas with no visible electrical filaments. Unlike corona, plasma is created at much lower voltage levels and temperature.

However, it has recently been discovered that the use of discharge treatments has its limitations with respect to adhesion characteristics between a secondary coating (i.e. a coating applied to a treated substrate that has been previously treated with a discharge treatment) and the treated substrate material (i.e. a bare substrate material coated with one or more layers of a primary coating material). Most specifically, it has been discovered that the adhesion characteristics between the applied secondary coating and the topmost primary coating layer of the treated substrate material, and between the primary coating layers of the treated substrate, and between the bottommost primary coating layer and the bare substrate varied, depending upon the length of discharge treatment of the topmost primary coating layer of the treated substrate material surface energy surface energy. Thus, it is no longer correct to assume that an increase in the surface energy alone of the treated substrate material to a level above the subsequently applied secondary coating is the only consideration in determining the adhesion characteristics for a coated article.

### SUMMARY OF THE INVENTION

Accordingly, the present invention provides a method for improving the adhesion characteristics of a coated article by increasing the surface energy of a treated substrate material using a corona or plasma discharge treatment prior to the application of a secondary coating material, in which the treatment is limited to a finite duration of time sufficient to increase the surface energy of the outer surface of the primary coating layer of the treated substrate to a desired level but insufficient to cause cohesive failure between any of the other primary coating layers of the coated article, or between the bottommost primary coating layer and bare substrate material, after application of the secondary coating.

The method consists of first providing a low surface energy substrate material and a higher surface energy secondary coating to be applied to the substrate material. The low surface energy substrate material consists of a non-polar or polar bare substrate material of any type coated with one or more layers of a primary coating material i.e. a coated substrate material). The surface energy any of the layers of the primary coating material and bare substrate material are each lower than the surface energy of the to-be applied higher energy secondary coating in its dried or cured state.

Next, the visible surface of the outermost one of the primary coating layers of the treated substrate material is subjected to a discharge treatment (corona discharge or plasma discharge) of sufficient length to increase the surface energy of the visible surface to a desired level above the surface energy level of the yet to be applied secondary coating layer, but insufficient length to adversely affect the adhesion characteristics between any of these primary coating layers or between the bottommost primary coating layer and the bare substrate. Finally, the secondary coating is applied to the treated substrate and at a desired thickness and cured or dried, depending upon its composition.

While the present invention may be used for any type of coated substrate and secondary coating, the present invention is ideally suited for introducing an ambiently-cured two-component polyurea/amine coating to a corona discharge treated top coated truck bed to form a bed liner.

These and other features and advantages of the present invention will become apparent from the following description of the invention, when viewed in accordance with the accompanying drawings and appended claims.

### BRIEF DESCRIPTION OF THE DRAWING

FIG. 1 is a perspective view of a truck bed substrate coated with a bed liner;

FIG. 2 is a method for forming the truck bed substrate coated with a bed liner according to the prior art; and

FIG. 3 is a method for forming the truck bed substrate coated with a bed liner according to a preferred embodiment of the present invention.

### DETAILED DESCRIPTION OF THE PREFERRED EMBODIMENT

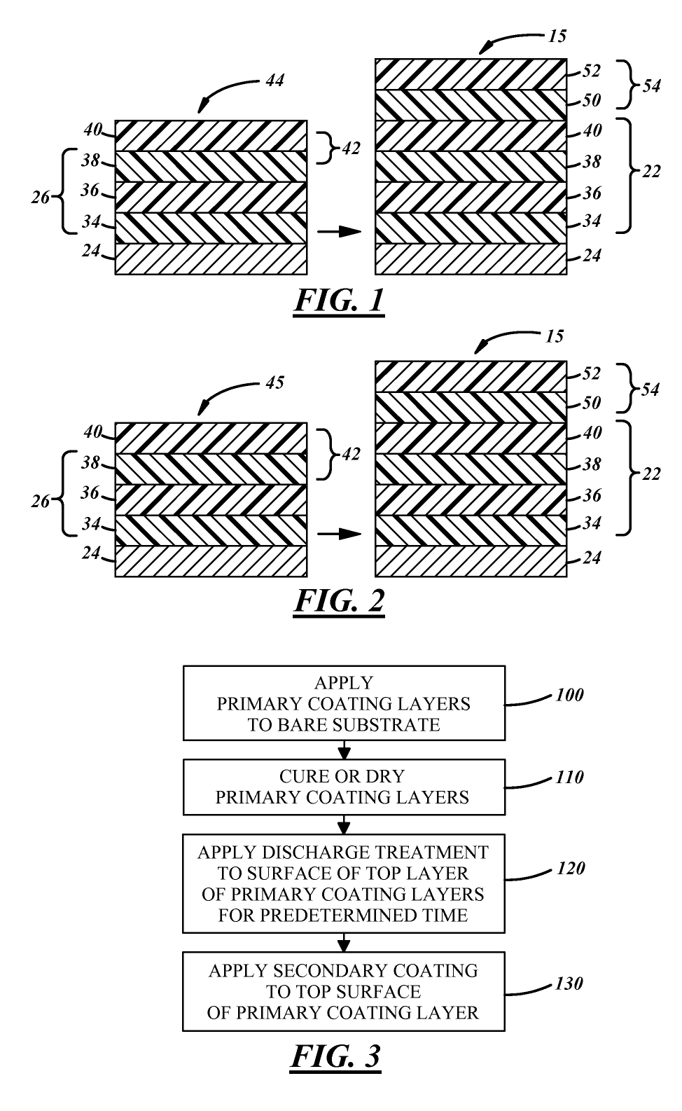

The present invention is directed at a method for improving the adherence of a higher surface energy secondary coating to a lower surface energy coated substrate material to form a coated article. The present invention is ideally suited for improving the adherence of a polymeric bed liner coating to a low surface energy top coated truck bed substrate material, as will be described and illustrated below in FIGS. 1-3.

The method according to a preferred embodiment of the present invention comprises the steps of providing a coated substrate material having a low surface energy, applying a corona discharge or plasma treatment to the visible surface of the coated substrate material for a predetermined amount of time sufficient to increase the surface energy of the coated substrate material, and applying a liquid secondary coating onto the treated higher surface energy coated substrate material, wherein the liquid is cured or otherwise dried to form a adhered secondary coating on the treated substrate material. The surface energy of outermost primary coating layer of the coated substrate material, in the absence of the discharge treatment, is lower than the surface energy of the to-be applied secondary coating. The discharge treatment raises the surface energy of the outer surface of the outermost layer of the primary coating layer to a level higher than that of the subsequently applied secondary coating to increase the wettability, and hence the adherence, of the secondary coating to the outermost layer of the primary coating layers of the treated substrate material.

As the present invention will describe, the length of time for applying the discharge treatment to the outermost layer of the primary coating layers of the treated substrate material must be precisely controlled. If the discharge treatment is too short, the surface energy of the low energy outermost layer of the primary coating layers of the treated substrate material will not be raised to a level sufficient to maximize the adherence of the secondary coating to the outermost layer of the primary coating layers of the treated substrate material. If the discharge treatment is too long, the adherence of the secondary coating to the topmost layer of the primary coating will be substantially greater than the adherence of between any two of the layers of the primary coating material or between the bottommost layer of the primary coating material and the bare substrate material, which will result in cohesive failure occurring between the primary coating layers or occurring between the bottommost primary coating layer and the bare substrate material.

The bare substrate material may consist of a naturally occurring or synthetically-produced material, including for example a plastic material or the like, that have a relatively low surface energy and are typically non-polar in nature. It is to be understood that the substrate may comprise any suitable substrate, including, but not limited to, metal stampings, carbon graphite composites, fiberglass, polycarbonates, ABS (“acrylonitrile-butadiene-styrene”), and any other structural polymeric materials. The bare substrate material is then coated with one or more layers of a primary coating material that produces a low surface energy finish coated substrate, or treated substrate material. Examples of primary coating materials that may be used to form the primary coating layers include air-dried or temperature cured one-component or two-component polymeric coating materials.

The term “higher surface energy secondary coating” refers to a secondary coating material that is applied to the outermost primary coating layer of the lower energy coated substrate material. The surface energy of the secondary coating is measured relative to that of the surface energy of the outermost primary coating layer. When the secondary coating has a higher surface energy than the outermost primary coating layer to which it is applied, the secondary coating will tend to bead, like water on a waxed surface, rather than wet out on the outermost primary coating layer. Conversely, when the secondary coating has a lower surface energy than the outermost primary coating layer, the secondary coating will tend to wet onto the outermost primary coating layer more easily, which those of ordinary skill in the art have generally recognized as improving adhesion between the secondary coating and the outermost primary coating layer.

It is to be understood that the application step of applying the secondary coating material to the outermost primary coating layer may comprise any suitable application means such as, for example, spraying, dipping, brushing, and it may be desired to utilize suitable hoods, ventilation means, and/or standard paint style spray booths. It is to be further understood that any of the application means may be performed manually and/or automatically and/or robotically. Finally, the polymeric secondary material is then dried or cured to form a film of a desired thickness that adheres to the underlying outermost primary coating layer to form the coated article.

The corona discharge treatments described in the present application are conventional in nature and provided from conventional corona treating systems. All corona discharge treating systems have two components. The first component is the power source and the second component is the treater station. The power source generally consists of a high frequency generator and a high voltage output transformer. In very general terms, the purpose of the power source is to raise the incoming electricity (typically 50/60 Hz, 230/460 V) to a higher frequency (10-35 kHz) and higher voltage (10 kV). The power source is commonly referred to as a power supply or a generator. Typically, power supplies are rated in kilowatts (kW) and can range from 500 W to 30 kW, depending on the application. The treater stations have a high voltage electrode and a ground electrode. A solid dielectric (insulating) material is needed to cover one of the two electrodes in order to generate a corona atmosphere, as opposed to a “lightening bolt” charge. In general terms, treater stations are broadly classified as either covered rolls or bare roll treater stations. Covered roll stations have the dielectric covering on the ground roll and the high voltage electrode is bare metal. Bare roll stations have the dielectric covering on the high voltage electrode and the ground electrode is bare metal.

Non-limiting examples of corona surface treater apparatus that may be used in treating the low surface energy substrate materials of the present invention include Corona Treater Model Nos. BD-20AC and BD-80, available from Electro-Technic Products, Inc. of Chicago, Ill.

Alternatively, a plasma discharge treatment may also be utilized. Like corona, plasma is the electrical ionization of a gas, but with plasma the gas is selected dependent on the material being treated and the application being performed. The plasma (glow) discharge creates a smooth, undifferentiated cloud of ionized gas with no visible electrical filaments. Unlike corona, plasma is created at much lower voltage levels and temperature.

One application that is ideally suited that utilizes the method of the present invention to improve the adherence of a two-component polymeric bed liner material 50 (i.e. the secondary coating) to a truck bed substrate 22 (coated or treated substrate material) for automobile truck bed applications. These truck bed liners 15 provide an additional protective liner material to the inside of the truck bed that allows the user's to transport and store materials while minimizing damage to the underlying substrate material that can result in corrosive damage over time.

An exemplary coated article, here a truck bed liner 15, is formed in accordance with the prior art as shown in FIG. 1 wherein a bed liner coating 50 is coupled to a truck bed substrate 22. The present invention, as shown in FIG. 2, illustrates the improved method for coupling of the bed liner coating 50 to the truck bed substrate 22. The substrate 22 preferably includes one or more layers 26 of polymeric coatings coupled onto a hard surface substrate material 24, depending upon its application. The layers 26, or primary coating layers 26, are applied one at a time to a steel substrate 24, preferably an electrogalvanized steel substrate 24, and include an electrodeposition coating layer 34, a primer layer 36 a basecoat layer 38 and a clearcoat layer 40. Collectively, the basecoat layer 38 and clearcoat layer 40 are commonly referred to as a topcoat layer 42.

As further shown in FIG. 1, a polymeric bed liner material 50 is then applied to the upper surface 44 of the topcoat layer 42 and cured or otherwise dried. The bed liner material 50 preferably consists of a two-component polymeric material applied onto the topcoat layer 42. A dust coating material 52 may be subsequently applied to the bed liner material 50 to provide texture to the outer surface.

The two-component bed liner material 50 and dust coating material 52 are formed of a two component, VOC free pure polyurea elastomeric coating based on amine terminated polyether resins, amine chain extenders and aliphatic isocyanate prepolymers that are processed thru high-pressure plural component processing equipment. Collectively, the bed liner material 50 and dust coating material 52 may alternatively be referred to as the secondary coating 54, which, in their liquid state, have a higher surface energy than the untreated upper surface 44 of the topcoat layer 42. The bed liner material 50 and dust coating 52 have a short pot life, and substantially cure within seconds of application onto the topcoat layer 42.

Subsequent testing of the peel strength of the truck bed liner 15 after application of the secondary coating 54 to the primary coating layers 26 has revealed significant issues regarding the adherence of the bed liner material 50 to the top coated surface 42. Specifically, in 90-degree peel tests, secondary coating 54 is easily peeled away from the top coated layer 42 with a minimum of pressure. Applicants believe that two factors, both related to the wettability of the bed liner material 50 onto the upper surface 44 of the top coated surface 42, contributed to this phenomenon. First, the low surface energy of the upper surface 44 relative to the higher surface energy of the liquid bed liner material 50 minimizes the amount of wetting of the bed liner material 50 on the upper surface 44 prior to the bed liner material curing. Second, the extremely fast cure rate of the bed liner material 50 also contributes to the minimal amount of wetting of the bed liner material 50 on the upper surface 44 prior to complete cure.

The present invention, as shown in FIG. 2 and described below in the logic flow diagram of FIG. 3, addresses the issue of wettability of the bed liner material 50 on the upper surface 44 of the top coat 42 without the need to change the composition of the secondary coating 54 or any of the primary coating layers 26 used to form the truck bed 15. Specifically, the present invention changes the surface energy of the upper surface of the top coated material 42 from a low surface energy upper surface 44 to a higher surface energy upper surface 45, through use of a corona or plasma discharge application, prior to application of the bed liner material 50. This allows the bed liner material 50 to wet out more easily onto the upper surface 45 of the top coated material 42. This is thought to improve the adherence of the bed liner material 50, and hence the secondary coating 54, to the top coated material 42.

As experiments below will illustrate, the length of time of the discharge treatment of the upper surface 44 of the top coated layer 42 is limited to a finite window of time in order to maximize the adherence between the secondary coating 54 and top coated layer 42, between all of the primary coating layers 26 relative to one another, and between the bottommost layer of the primary coating layers 26 (here the electrodeposition coating layer 34) and the bare substrate material 24. If the discharge treatment is too short, the surface energy of the upper surface 44 of the top coated material 42 will not be raised to a level sufficient to maximize the adherence of the bed liner material surface energy 50 to the top coated material 42. If the discharge treatment is too long, cohesive failure may occur between any two primary coating layers 26 or between the bottommost layer, here the electrodeposition coating layer 34, of the polymeric coating material 26 and the bare substrate material 24.

FIG. 3 illustrates a logic flow diagram for forming the truck bed liner 15 of FIG. 2 in accordance with a preferred method. The method of FIG. 3 is applicable to the application of any secondary coating to the surface of substrate material to form a coated article and should not be considered limited to the particular application.

In Step 100, the primary coating layers 26 comprising the electrodeposition coating layer 34, primer layer 36, and topcoat layers 42 are applied by conventional means under conditions well known to those of ordinary skill in the automotive coatings industry and form no part in the inventive aspect of the present invention.

Next, in Step 110, the topcoat layer 42, after application, is cured or otherwise dried. The upper surface of the cured or dried topcoat layer 42 is characterized as a low surface energy layer 44.

In Step 120, a corona discharge or plasma discharge is applied to the upper surface 44 of the top coat layer 42 for a period of time sufficient to raise the surface energy to a high surface energy upper surface 45 that is above the surface energy of the yet to be applied secondary coating 54. The length of time is limited to a period of time sufficient to increase the surface energy of the upper surface 44 above that of the bedliner material 50 yet insufficient to otherwise cause cohesive failure between layers 26 or between the electrodeposition layer 34 and the bare substrate material 24. Experimentation as to the amount of time necessary to achieve this desired result is application dependent, as one of ordinary skill recognizes, depending upon the composition and surface energy of the material comprising the top coat layer 42 and further upon the surface energy of the yet to be applied the bed liner material 50, and further yet upon the surface energy of each of the respective layers 26 and bare substrate material 24,

For a bed liner material 50 applied to a top coated layer 42 as described in FIG. 2, which preferably utilizes an Electro-Technic Products Laboratory Corona Treater (BD-20AC) with an output voltage of between about 10,000 to 48,000 and a frequency of between about 4-5 MHz, the discharge time should be between a few seconds and about 4 minutes

in Step 130, the application of the bed liner material 50 and dust coating 52 are applied to the higher energy upper surface 45 of the top coat layer 42 by conventional spraying techniques and form no part of the inventive aspect of the present invention.

Experimentation, as discussed in Examples 1-4 below, has shown that a bed liner material 50 introduced to the topcoat layer 42 achieved significant improvement in adherence to the underlying topcoat layer 42 when treated with a corona discharge treatment for a predetermined limited amount of time. However, as the length of corona discharge treatment increased past a predetermined amount of time, the performance benefits gained were lost, as the panels experienced cohesive paint failure as described below.

### EXPERIMENT 1

A series of electrogalvanized steel panels were prepared and evaluated with coatings and bed liners designed to substantially match the exemplary secondary coating 54 coupled to a truck bed substrate 22 as illustrated in FIGS. 1 and 2.

For this experiment, a series of electogalvanized panels were first coated with a layer of Dupont Cormax 6 electrocoat (ACT Material Code Cormax 6 EP) applied using conventional electrodeposition techniques and thicknesses commonly found in automotive truck beds. The electrocoat was cured to the panels in an oven at standard baking conditions. Next, a layer of Dupont black primer (ACT Material Code 554DN082) was applied to electrocoated panels, again using conventional application techniques and at conventional film thicknesses Finally, a layer of Dupont Black Waterborne Basecoat (ACT Material Code 686DN027(S40343)) is applied to the black primer layer at conventional film thicknesses. A layer of Dupont Gen V Clearcoat (ACT Material Code RK8073 (RKA01199)) was applied wet-on-wet to the basecoat layer at conventional film thicknesses. A first portion of the top coated panels were cured in an oven at 285 degrees Fahrenheit for 17 minutes (standard bake), while the rest of the panels were cured in an oven at 325 degrees Fahrenheit for 17 minutes (overbake). The surface energy of top coated surface of each of the panels was measured using Dyne pens and confirmed to be around 6 dynes/cm.

Next, a portion of the panels (both standard and overbaked) were treated with an Electro-Technic Products Laboratory Corona Treater (BD-20AC) with an output voltage of between about 10,000 to 48,000 and a frequency of between about 4-5 MHz. This device provides continuous corona discharge for a minimal amount of time sufficient to raise the surface energy from an initial level of about 6 dynes/cm to a level at or exceeding 40 dynes/cm.

The other portion of the standard bake and overbaked panels remained untreated.

Finally, a layer of bed liner material and dustcoat was spray applied using standard spray equipment at between 140 and 165 degrees Fahrenheit, and more preferably 165 degrees Fahrenheit, to each of the panels at substantially uniform cured film thicknesses of between about 40 and 55 mils. Preferably, this is done at a mix pressure between 1800 and 2500 psi, and more preferably around 2000 psi, and at a coating thickness of about 15 mils per pass. The bed liner material consists of a two component, VOC free pure polyurea elastomeric coating based on amine terminated polyether resins, amine chain extenders and aliphatic isocyanate prepolymers. The bed liner material ambiently cures at the application temperature within a matter of minutes.

Each of the panels was then evaluated for peel adhesion using a 90-degree peel test. The 90-degree peel test is a test wherein a mandrel or similar device is utilized to try to peel the layers of a coating off a panel. Weights are added to the mandrel device to apply more force on the coating until the coating peels from the substrate. More weight, in terms of pli (pounds per linear inch), indicate better adhesion. This testing confirmed that peel adhesion between the bed liner layer and topcoat layer went from about 2 pli for panels not treated with the corona discharge to greater than 25 pli for panels treated with the corona discharge treatment. This confirmed that the corona discharge treatment improved adhesion between the bed liner layer and topcoat layer.

### EXPERIMENT 2

In this experiment, the panels were top coated and cured as described above in Experiment 1. Next, the panels (both standard and overbaked) were treated with an Electro-Technic Products Laboratory Corona Treater (BD-20AC) with an output voltage of between about 10,000 to 48,000 and a frequency of between about 4-5 MHz for a minimal amount of time sufficient to raise the surface energy from an initial level of about 6 dynes/cm to a level at or exceeding 40 dynes/cm.

Finally, a layer of bed liner material and dustcoat as described in Experiment 1 was applied to each of the panels at various film thicknesses, bed liner to dustcoat flash times, and booth temperature/humidities. A summary of the various experimental parameters is detailed in Table 1:

TABLE I

| Application DOE | | | | | |
|---|---|---|---|---|---|
| Factor | Level 1 | Level 2 | Level 3 | KTP Paint System | ACT Material Code |
| Thickness (mil(s) | 30 | 65 | 100 | Electrogalvanized Steel | |
| BC to Dustcoat | 2 | 7 | 12 | Dupont Cormax 6 Electrocoat | Cormax 6 EP |
| Flash (mm) | | | | | |
| Booth Temp/Humidity | 60 F./30% | 85 F./85% | | Dupont Black Prime | 554DN082 |
| | | | | Dupont Black Waterborne | 686DN027(S40343) |
| | | | | Basecoat | |
| | | | | Dupont Gen VI Clearcoat | RK8O1 4(RKS40348) |

| | | | | Bedliner |
|---|---|---|---|---|
| | | | | Application |
| | | Bedliner | Bedliner | Booth |
| RunOrder | Blocks | Thickness | BC/Dustcoat | Temp/Humidity |
| 1 | 1 | 1 | 3 | 1 |
| 2 | 1 | 3 | 2 | 1 |
| 3 | 1 | 1 | 1 | 1 |
| 7 | 1 | 3 | 1 | 1 |
| 8 | 1 | 3 | 3 | 1 |
| 9 | 1 | 2 | 2 | 1 |
| 10 | 1 | 2 | 3 | 1 |
| 11 | 1 | 3 | 3 | 1 |
| 16 | 1 | 3 | 2 | 1 |
| 17 | 1 | 1 | 3 | 1 |
| 18 | 1 | 1 | 2 | 1 |
| 20 | 1 | 2 | 2 | 1 |
| 23 | 1 | 2 | 1 | 1 |
| 24 | 1 | 2 | 3 | 1 |
| 26 | 1 | 1 | 3 | 1 |
| 28 | 1 | 2 | 2 | 1 |
| 30 | 1 | 2 | 3 | 1 |
| 32 | 1 | 1 | 2 | 1 |
| 34 | 1 | 3 | 1 | 1 |
| 36 | 1 | 3 | 3 | 1 |
| 39 | 1 | 2 | 1 | 1 |
| 41 | 1 | 2 | 1 | 1 |
| 42 | 1 | 3 | 1 | 1 |
| 44 | 1 | 1 | 2 | 1 |
| 48 | 1 | 1 | 1 | 1 |
| 50 | 1 | 3 | 2 | 1 |
| 53 | 1 | 1 | 1 | 1 |

Each of the panels described in Table 1 was then evaluated for peel adhesion using a 90-degree peel test. This testing confirmed that peel adhesion between the bed liner layer and topcoat layer was greater than 25 pli for all of the panels. This experiment, in conjunction with Figure, helps to confirm that the corona discharge treatment improved adhesion between the bed liner and topcoat layer, regardless of the processing parameters of the subsequently applied bed liner material.

### EXPERIMENT 3

In this experiment, the panels were top coated and cured as described above in Experiment 1. Next, the panels (both standard and overbaked) were treated with an Electro-Technic Products Laboratory Corona Treater (BD-20AC) with an output voltage of between about 10,000 to 48,000 and a frequency of between about 4-5 MHz for a minimal amount of time sufficient to raise the surface energy from an initial level of about 6 dynes/cm to a level at or exceeding 40 dynes/cm.

Next, a bed liner coating having a varying ratio of the components (polyurea/amine to isocyanate) of the bed liner material was introduced to the treated top coated panels. Moreover, some panels were subjected to bed liner coating repair, wherein a portion of the bed liner coating was removed and resprayed to a consistent thickness Each of the panels was then evaluated for peel adhesion using a 90-degree peel test. The results were summarized in Tables II and III.

| Adhesion DOE | | | | | |
|---|---|---|---|---|---|
| Factor | Level 1 | Level 2 | Level 3 | KTP Paint System | ACT Material Code |
| Topcoat Cure | Standard | Overcure | | Electrogalvanized Steel | |
| Bedliner Repair | No Repair | Repair | | Dupont Cormax 6 Electrocoat | Cormax 5 EP |
| Bedliner Component Mix Ratio | 0.9:1 | 1:1 | 1:0.9 | Dupont Black Prime | 554DN082 |
| (refers to initial bedliner | | | | Dupont Black Waterborne | 666DN027(S40343) |
| application, not repair) | | | | Basecoat | |
| | | | | Dupont Gen V Clearcoat | RK8073(RKAOI 199) |

| | |
|---|---|
| Standard Topcoat Cure | 17 mm @ 285 F. |
| Overbake No Repair | 17 mm @ 325 F. |

| | | | | Bedliner |
|---|---|---|---|---|
| | | Topcoat | Bedliner | Component |
| RunOrder | Blocks | Bake | Repair | Mix/Ratio |
| 2 | 1 | 1 | 1 | 2 |
| 3 | 1 | 1 | 1 | 1 |
| 4 | 1 | 2 | 1 | 2 |
| 9 | 1 | 2 | 1 | 3 |
| 10 | 1 | 2 | 1 | 1 |
| 14 | 1 | 2 | 1 | 3 |
| 17 | 1 | 2 | 1 | 3 |
| 19 | 1 | 2 | 1 | 2 |
| 20 | 1 | 1 | 1 | 1 |
| 21 | 1 | 2 | 1 | 1 |
| 22 | 1 | 2 | 1 | 2 |
| 23 | 1 | 1 | 1 | 2 |
| 26 | 1 | 2 | 1 | 1 |
| 30 | 1 | 1 | 1 | 2 |
| 32 | 1 | 1 | 1 | 2 |
| 33 | 1 | 1 | 1 | 3 |
| 34 | 1 | 1 | 1 | 1 |
| 36 | 1 | 1 | 1 | 3 |

TABLE III

| Bedliner Component | | |
|---|---|---|
| Mix/Ratio | | |
| (Polyurea/Amine:Isocyanate) | Shore A | Pull |
| 1:1 | 96 | >50 lbs |
| 1:1 | 96 | >50 lbs |
| 1:1 | 96 | >25 lbs |
| 1:1 | 96 | >50 lbs |
| .9:1 | 96 | >25 lbs |
| 1:.9 | 94 | >50 lbs |
| .9:1 | 96 | >50 lbs |
| 1:.9 | 96 | >25 lbs |

This testing confirmed that peel adhesion between the bed liner layer and topcoat layer was greater than 25 pli for all of the panels, regardless of the ratio of polyurea/amine to isocyanate in the coating. This experiment, in conjunction with Experiment 1, helps to confirm that the corona discharge treatment improved adhesion between the bed liner and topcoat layer, regardless of the processing parameters of the underlying layers, the ratio of components in the subsequently applied bed liner material, or repairs made post application of the bedliner.

### EXPERIMENT 4

A series of electrogalvanized steel panels were prepared and evaluated with coatings and bed liners as described above in Experiment 1, with the only exception being the amount of corona discharge applied to the upper surface of the topcoat prior to introduction of the bed liner material.

In this experiment, a portion of the panels was treated for 0, 1, 2, and 4 minutes, respectively, with the corona discharge coater. Next, each of the panels was then evaluated for peel adhesion using a 90-degree peel test. The results are shown in Table IV:

TABLE IV

| LENGTH OF | | |
|---|---|---|
| TREATMENT | SURFACE ENERGY | 90 DEGREE PULL |
| 0 Minutes | 6 Dynes/cm | <2 lbs bed liner failure |
| 1 Minute | 38–42 Dynes/cm | >25 lbs bed liner failure |
| 2 Minutes | 38–42 Dynes/cm | 25–30 lbs bed liner failure |
| 4 Minutes | >44 Dynes/cm | 25 lbs paint failure |

The results confirmed first that the surface energy improved and maintained higher surface energy after corona discharge treatment. The results also showed that peel adhesion for untreated panels was about 2 pli, and the failure occurred between the bed liner and top coated layer. Moreover, peel adhesion for panels discharge treated at 1 and 2 minutes exceeded 25 pli, with failure occurring between the bed liner material and the topcoat layer. Panels treated for 4 minutes showed a drop off in their peel strength, with cohesive failure occurring not between the bed liner and topcoat layer, but instead between the topcoated layer or primer layer and the electrocoat layer (i.e. cohesive failure of the paint layer).

Thus, Experiment 4 confirms that the length of time for applying the discharge treatment to the upper surface of the top coated layer must be precisely controlled. If the discharge treatment is too short, the surface energy of the low energy substrate material will not be raised to a level sufficient to maximize the adherence of the secondary coating to the top coated layer. If the discharge treatment is too long, the adherence of any underlying coating to the substrate (here, the bedliner, the topcoat, primer and/or electrocoated layer to the steel substrate) can be compromised.

While the present invention has been proven with respect to adhering a bed liner material to a topcoat for a truck bed application, it is anticipated that the present invention may be utilized to improve the adherence of any secondary coating to an untreated low energy substrate material (bare or coated). Thus, the present is not limited to its preferred application. While particular embodiments of the invention have been shown and described, numerous variations or alternate embodiments will occur to those skilled in the art. Accordingly, it is intended that the invention be limited only in terms of the appended claims.

What is claimed is:

1. A method for forming a coated article comprising:
forming a coated substrate material comprising at least one primary coating layer coupled to a bare substrate material, an outermost one of said at least one primary coating layer having an upper surface, said upper surface opposite said bare substrate material;
applying a discharge treatment to said upper surface for a predetermined amount of time to increase the surface energy of said upper surface to a predetermined level; and
applying a secondary coating material to said upper surface;
wherein said predetermined level of the surface energy of said upper surface of said at least one primary coating layer is higher than a surface energy of said secondary coating material when said secondary coating material is applied and cured to said upper surface and wherein said predetermined amount of time is insufficient to cause cohesive failure between each layer of said at least one primary coating layer or insufficient to cause cohesive failure between a bottommost layer of said at least one primary coating layer and said bare substrate material.

2. The method of claim 1, wherein applying a discharge treatment to an outer surface of said at least one primary coating layer comprises:
applying a corona discharge treatment to said upper surface for a predetermined amount of time to increase the surface energy of said upper surface to a predetermined level.

3. The method of claim 1, wherein applying a discharge treatment to an upper surface of said at least one primary coating layer comprises:
applying a plasma discharge treatment to said upper surface for a predetermined amount of time to increase the surface energy of said upper surface to a predetermined level.

4. The method of claim 1 further comprising:
providing a secondary coating material having a predetermined surface energy in a cured state;
measuring a surface energy of said upper surface; and
applying a discharge treatment to said upper surface for the minimal period of time sufficient to raise said surface energy to a level greater than or equal to said surface energy of said secondary coating material.

5. The method of claim 1 further comprising:
providing a secondary coating material having a predetermined surface energy in a cured state;
measuring a surface energy of said bare substrate material;
measuring a surface energy of each of said at least one primary coating layers not including said upper surface of said outermost one of said at least one primary coating layers;
measuring a surface energy of said upper surface; and
applying a discharge treatment to said upper surface for the period of time sufficient to raise said surface energy of said upper surface to a level greater than or equal to said surface energy of said secondary coating material yet insufficient to be substantially greater than each of said surface energy of each of said at least one primary coating layer not including said upper surface and insufficient to be substantially greater than said bare substrate material.

6. A truck bed having a bed liner formed in accordance with the method of claim 1.

7. A method for coupling a truck bed liner to a truck bed comprising:
providing a clean bare substrate material of a truck bed;
coupling at least one layer of a polymeric primary coating material to said clean bare substrate material to form a coated substrate material, an outermost layer of said at least one layer of said polymeric primary coating material having an upper surface;
applying a discharge treatment to said upper surface for a predetermined amount of time to increase the surface energy of said upper surface to a predetermined level; and
applying a bed liner material to said upper surface; and
curing said bed liner material to said upper surface;
wherein said predetermined level of the surface energy of said upper surface is higher than a surface energy of said secondary coating material when said secondary coating material is applied and cured to said upper surface and wherein said predetermined amount of time is insufficient to cause cohesive failure between each layer of said at least one layer of said polymeric primary coating material or insufficient to cause cohesive failure between a bottommost layer of said at least one layer of said polymeric primary coating material and said bare substrate material.

8. The method of claim 7 further comprising:
applying a layer of a dust coating material to said bed liner material; and
curing said layer of said dust coating material to said bed liner material.

9. The method of claim 7, wherein applying a discharge treatment to an upper surface comprises:
applying a corona discharge treatment to said upper surface for a predetermined amount of time to increase the surface energy of said upper surface to a predetermined level.

10. The method of claim 7, wherein applying a discharge treatment to an upper surface comprises:
applying a plasma discharge treatment to said upper surface for a predetermined amount of time to increase the surface energy of said upper surface to a predetermined level.

11. The method of claim 7 further comprising:
providing a bed liner material having a predetermined surface energy in a cured state;
measuring a surface energy of said upper surface; and
applying a discharge treatment to said upper surface of said at least one coating layer for the minimal period of time sufficient to raise said surface energy to a level greater than or equal to said surface energy of said bed liner material.

12. The method of claim 7 further comprising:
providing a secondary coating material having a predetermined surface energy in a cured state;
measuring a surface energy of said bare substrate material;
measuring a surface energy of each of said at least one layer of said polymeric primary coating material not including said upper surface of said outermost one of said at least one coating layers;
measuring a surface energy of said upper surface of said of outermost one of said at least one coating layer; and
applying a discharge treatment to said upper surface for the period of time sufficient to raise said surface energy to a level greater than or equal to said surface energy of said secondary coating material yet insufficient to be substantially greater than each of said respective surface energies of each of said at least one layer of said polymeric primary coating material and insufficient to be substantially greater than said bare substrate material.

13. The method of claim 7, wherein coupling at least one layer of a polymeric primary coating material to said clean bare substrate material to form a coated substrate material, an outermost layer of said at least one layer of said polymeric primary coating material having an upper surface comprises:
coupling at least two layers of a polymeric primary coating material to said clean bare substrate material to form a coated substrate material, an outermost layer of said at least two layers of said polymeric primary coating material having an upper surface.

14. The method of claim 7, wherein coupling at least one layer of a polymeric primary coating material to said clean bare substrate material to form a coated substrate material, an outermost layer of said at least one layer of said polymeric primary coating material having an upper surface comprises:
applying an electrodeposition coating layer to said bare substrate material;
applying a primer coating layer to said electrodeposition coating layer;
applying a basecoat layer to said primer coating layer; and
applying a clear coat layer to said basecoat layer.
